(19) United States
(12) Patent Application Publication
(10) Pub. No.: US 2026/0061571 A1
(43) Pub. Date: Mar. 5, 2026

(54) Ratcheting Combination Wrench

(71) Applicant: ZHEJIANG MAXTOP TOOLS MANUFACTURE CO., LTD., Wenling City (CN)

(72) Inventor: NENG-CHIA SHIH, Changhua (TW)

(21) Appl. No.: 18/826,124

(22) Filed: Sep. 5, 2024

(51) Int. Cl. B25B 13/46; B25B 13/04; B25B 23/00

(52) U.S. Cl. CPC B25B 13/46; B25B 13/04; B25B 23/0028

(57) ABSTRACT

A ratcheting combination wrench may include a handle, a tool head, and a control member. The handle has a first lug and a second lug which are located symmetrically at one end of the handle, and a connecting space is formed between the first lug and the second lug. A shaft hole penetrates through the first lug and the second lug to communicate with the connecting space. A detent hole penetrating through the first lug and the second lug is located below the shaft hole, and a partial of the detent hole is located below the bottom surface of the connecting space, and an interconnected arc groove is formed on the bottom surface of the connecting space corresponding to the detent hole. The tool head comprises a working teeth and a pivot lug, and an axis hole penetrates through two ends of the pivot lug.

### FIELD OF THE INVENTION

The present invention relates to a wrench and more particularly to a wrench with an adjustable angle structure.

### BACKGROUND OF THE INVENTION

A conventional angle-adjustable wrench comprises a ratchet head with a positioning end and several first engagement sections, a handle with a first end and a second end, and a position member. The first end has two ears pivotally connected to the positioning end, a space defined between the ears, an operating hole, a communicating hole connecting the space and the operating hole, and a receiving hole communicating with the operating hole. The positioning member has an operating pin mounted in the operating hole, a block mounted in the communicating hole, and a spring and a stopper respectively mounted in the receiving hole. The operating pin comprises a recess surface, and the block has a driven end and several second engagement sections. When the operating pin moves to a locked position, the recess surface presses against the driven end, forcing the first and second engagement sections to interlock. When the operating pin moves to an unlocked position, the recess surface releases the driven end, allowing the second engagement sections to disengage from the first engagement sections.

However, the conventional wrench has following disadvantages: (i) the block in a ratchet wrench operates vertically between the operating pin and the positioning end of the ratchet head, and although the rachet head cannot rotate when the operating pin is in the locked position under normal conditions, if the user improperly force s the ratchet head to rotate, the vertically loaded block may easily fracture due to excessive shear force; (ii) the operating pin may also be deformed or damaged by the vertically applied force from the block, which can result in the positioning member failing to engage and position the ratchet head accurately, so as to affect the practicality and durability of the wrench. Therefore, there remains a need for a new and improved design for a ratcheting combination wrench to overcome the problems presented above.

### SUMMARY OF THE INVENTION

The present invention provides a ratcheting combination wrench comprising a handle, a tool head, and a control member. The handle has a first lug and a second lug which are located symmetrically at one end of the handle, and a connecting space is formed between the first lug and the second lug. A shaft hole penetrates through the first lug and the second lug to communicate with the connecting space. A detent hole penetrating through the first lug and the second lug is located below the shaft hole, and a partial of the detent hole is located below the bottom surface of the connecting space, and an interconnected arc groove is formed on the bottom surface of the connecting space corresponding to the detent hole, and a stop wall is formed on the outer side of the second lug to block the outer end of the detent hole. The tool head comprises a working teeth and a pivot lug, and an axis hole penetrates through two ends of the pivot lug. The axis hole is oriented in a direction different from and intersecting with the diameter direction of the working teeth, and a shaft bolt passes through the shaft hole and the axis hole to pivotally secure the pivot lug so that the pivot lug is adapted to swing back and forth within the connecting space. The bottom edge of the pivot lug has an arc-shaped locking portion centered around the axis hole, and the locking portion has continuous locking teeth on the outer periphery. The control member has an elastic member and a control column, and the elastic member positioned into the detent hole of the second lug is abutted against the stop wall at one end, and the control column is positioned between the detent hole and the interconnected arc groove. A freewheel section and a locking section are formed on the outer periphery of the control column, and the freewheel section is cut horizontally to form a flat plane. A plurality of detent teeth protrude from the surface of the locking section and are located higher than the freewheel section. The freewheel section and the locking section are respectively received in the interconnected arc groove and faced to the connecting space. The detent teeth of the locking section protrude into the connecting space to interlock with the locking teeth of the locking portion, enabling synchronized movement. An end of the control column adjacent to the locking section has a locating wall which is tightly abutted against the locking section, and the locating wall is abutted against the other end of the elastic member. The angle and position of the tool head is adjusted through pressing and releasing the control column.

In one embodiment, the shaft hole on the first lug comprises an internal thread section on the inner periphery of shaft hole, and the shaft bolt has a tool hole at one end and an external thread section at the other end, so as to screw and secure the shaft bolt together with the shaft hole.

In another embodiment, at least half of the detent hole is positioning below the bottom surface of the connecting space.

In still another embodiment, the area of the freewheel section is greater than the width of the locking portion of the pivot lug, and the area of the locking section is smaller than the freewheel section and is configured to be fully put into the detent hole of the second lug.

In a further embodiment, the other end of the control column has a pressing portion protruding out from the detent hole of the first lug.

Comparing with conventional ratcheting combination wrench, the present invention is advantageous because: (i) the control member is connected into the detent hole in the position parallel to the locking portion so that when the handle and the tool head are locked through the control member, the locking section of the control column are firmly engaged and positioned with the locking portion, so as to effectively balance the forces and reduce structural stress, further minimizing the risk of tooth wear, deformation, or even breakage; and (ii) when adjusting the tool head, pressing the control column to retract the locking section, and the locking section is disengaged with the locking section of the pivot lug, allowing the tool head to be adjusted freely, and releasing the control column allows the elastic member to push the control column back to its original position, quickly engage the locking section with the locking portion, so as to easily adjust the angle and position of the tool head, thereby enhancing the practicality and durability of the wrench.

### BRIEF DESCRIPTION OF THE DRAWINGS

FIG. 1 is a three-dimensional assembly view of a ratcheting combination wrench of the present invention.

FIG. 2 is an exploded view of the ratcheting combination wrench of the present invention.

FIG. 3 is a three-dimensional view of another embodiment of a tool head of the ratcheting combination wrench of the present invention.

FIG. 4 is a sectional assembly view of the ratcheting combination wrench of the present invention.

FIG. 5 is a sectional assembly view from another angle of the ratcheting combination wrench of the present invention.

FIG. 6 is a sectional view illustrating a control column of the ratcheting combination wrench of the present invention is pressed.

FIG. 7 is a sectional view from another angle illustrating the control column of the ratcheting combination wrench of the present invention is pressed.

FIG. 8 is a schematic view illustrating the tool head of the ratcheting combination wrench of the present invention is adjusted.

FIG. 9 is a sectional view illustrating the control column of the ratcheting combination wrench of the present invention is released and back to its original position.

FIG. 10 is a three-dimensional view illustrating the tool head of the ratcheting combination wrench of the present invention is adjusted to a working position.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

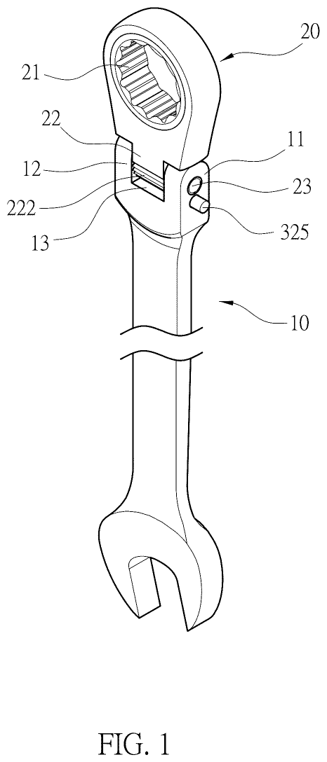

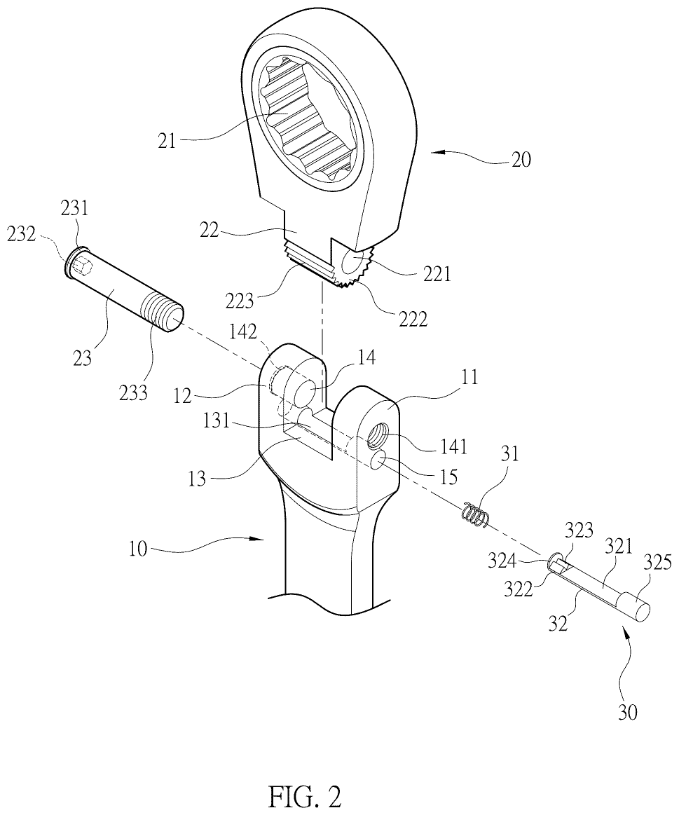

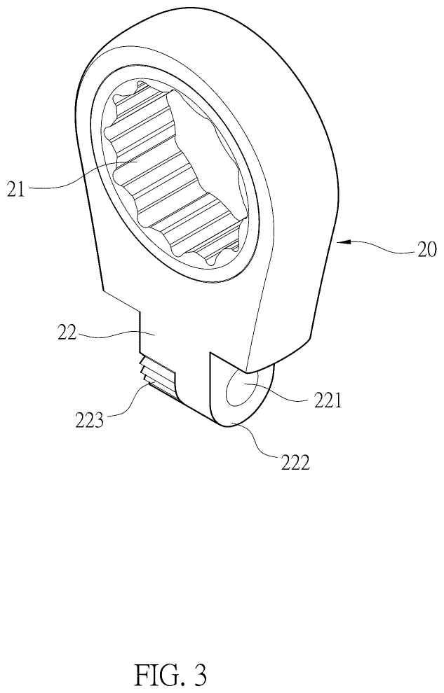

Referring to FIGS. 1, 2 and 4, the present invention provides a ratcheting combination wrench comprising a handle (10), a tool head (20), and a control member (30). The handle (10) has a first lug (11) and a second lug (12) which are located symmetrically at one end of the handle (10), and a connecting space (13) is formed between the first lug (11) and the second lug (12). A shaft hole (14) penetrates through the first lug (11) and the second lug (12) to communicate with the connecting space (13). The shaft hole (14) on the first lug (11) comprises an internal thread section (141) on the inner periphery of shaft hole (14), and a first groove (142) is extended from an outer side of the shaft hole (14) on the second lug (12). Also, a detent hole (15) penetrating through the first lug (11) and the second lug (12) is located below the shaft hole (14), and at least half of the detent hole (15) is positioning below the bottom surface of the connecting space (13), and an interconnected arc groove (131) is formed on the bottom surface of the connecting space (13) corresponding to the detent hole (15), and a stop wall (151) is formed on the outer side of the second lug (12) to block the outer end of the detent hole (15). The tool head (20) comprises a working teeth (21) and a pivot lug (22), and an axis hole (221) penetrates through two ends of the pivot lug (22). The axis hole (221) is oriented in a direction different from and intersecting with the diameter direction of the working teeth (21), and a shaft bolt (23) passes through the shaft hole (14) and the axis hole (221) to pivotally secure the pivot lug (22) so that the pivot lug (22) is adapted to swing back and forth within the connecting space (13). Moreover, the shaft bolt (23) has a blocking portion (231) at one end and an external thread section (233) at the other end, and a tool hole (232) is formed on the surface of the blocking portion (231). The shaft bolt (23) is threaded into the shaft hole (14), and the blocking portion (231) is positioned and abutted against the first groove (142). Additionally, the bottom edge of the pivot lug (22) has an arc-shaped locking portion (222) centered around the axis hole (221), and the locking portion (222) has continuous locking teeth (223) on the outer periphery. In one embodiment, the locking teeth (223) are distributed across the entire locking portion (222), and in another embodiment, the locking teeth (223) cover at least half of the locking portion (222) (as shown in FIG. 3). The control member (30) has an elastic member (31) and a control column (32), and the elastic member (31) positioned into the detent hole (15) of the second lug (12) is abutted against the stop wall (151) at one end, and the control column (32) is positioned between the detent hole (15) and the interconnected arc groove (131). A freewheel section (321) and a locking section (322) formed on the outer periphery of the control column (32) is faced to the connecting space (13), and the area of the freewheel section (321) is greater than the width of the locking portion (222) of the pivot lug (22), and the freewheel section (321) is cut horizontally to form a flat plane. The area of the locking section (322) is smaller than the freewheel section (321) and can be fully put into the detent hole (15) of the second lug (12), and a plurality of detent teeth (323) protrude from the surface of the locking section (322) and are located higher than the freewheel section (321). An end of the control column (32) adjacent to the locking section (322) has a locating wall (324) which is closely abutted against the locking section (322), and the locating wall (324) is abutted against the other end of the elastic member (31). Also, the other end of the control column (32) has a pressing portion (325) protruding out from the detent hole (15) of the first lug (11), so that the pressing portion (325) is pressed to control the angle adjustment and position of the tool head (20).

Structurally, referring to FIGS. 1, 2, 4 and 5, the elastic member (31) and the control column (32) are sequentially assembled into the detent hole (15), and the elastic member (31) positioned in the detent hole (15) of the second lug (12) is abutted against the stop wall (151). The control column (32) is inserted into the detent hole (15) with the locating wall (324) facing inward, and the locating wall (324) is abutted against the other end of the elastic member (31). Furthermore, the elastic member (31) is abutted between the locating wall (324) and the stop wall (151), and the freewheel section (321) and the locking section (322) are respectively received in the interconnected arc groove (131) and faced to the connecting space (13). The pivot lug (22) of the tool head (20) is pivotally connected into the connecting space (13) between the first lug (11) and the second lug (12), and the shaft bolt (23) is configured to pass through and screw into the aligned of the shaft hole (14) of the second lug (12), the axis hole (221), and the shaft hole (14) of the first lug (11), so that the tool head (20) is adapted to pivot back and forth within the connecting space (13) around the axis of the shaft bolt (23). Moreover, the locking portion (222) of the pivot lug (22) is coupled with the control column (32) between the freewheel section (321) and the locking section (322), and the control column (32) is pushed outward by the elastic member (31) to press the locating wall (324) against one lateral side of the pivot lug (22), and the detent teeth (323) of the locking section (322) protrude into the connecting space (13) to interlock with the locking teeth (223) of the locking portion (222), enabling synchronized movement. The pivot lug (22) is adapted to position the control column (32) to prevent the control column (32) from dislodged from the detent hole (15). In addition, through the mutual engagement of the locking teeth (223) and the detent teeth (323), the handle (10) and the tool head (20) maintain a normal engaged state by the control column (32).

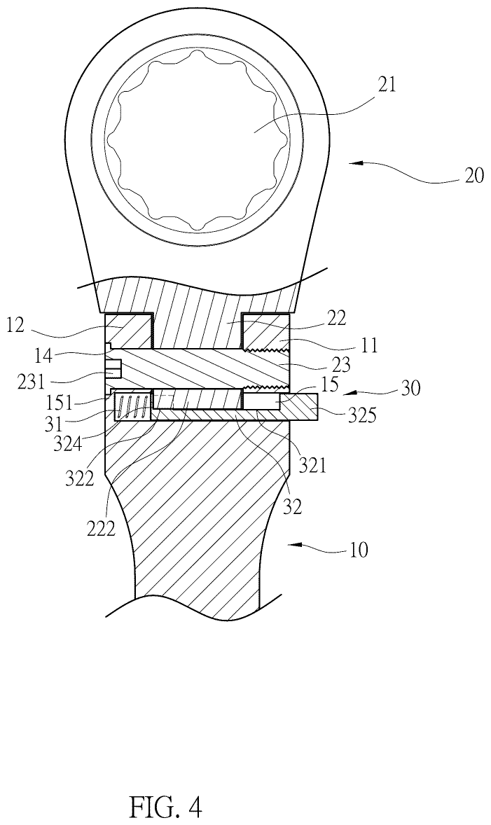

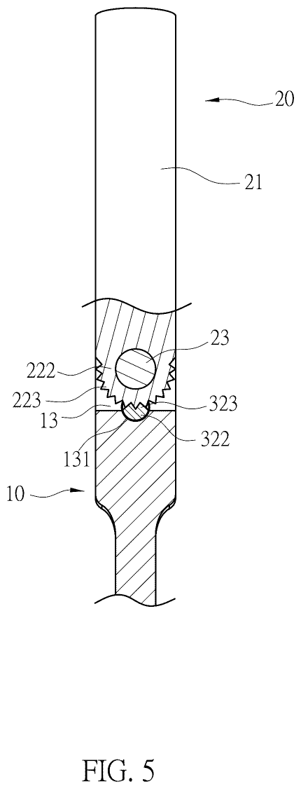

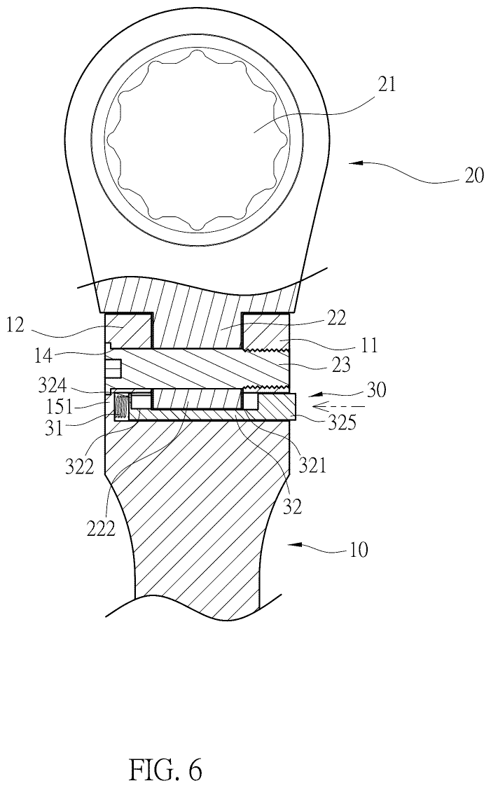

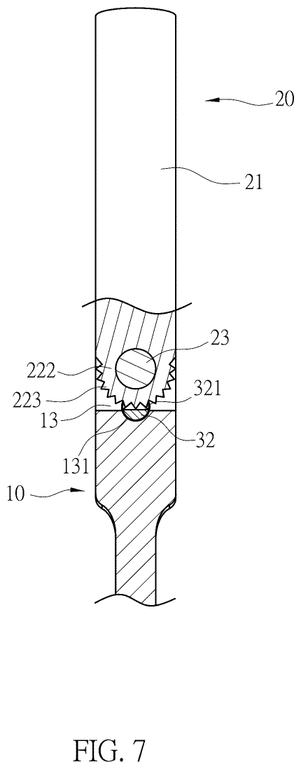

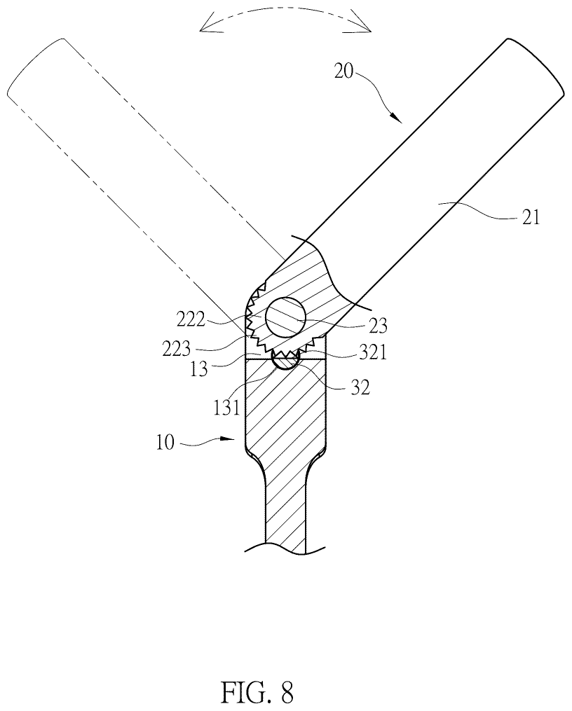

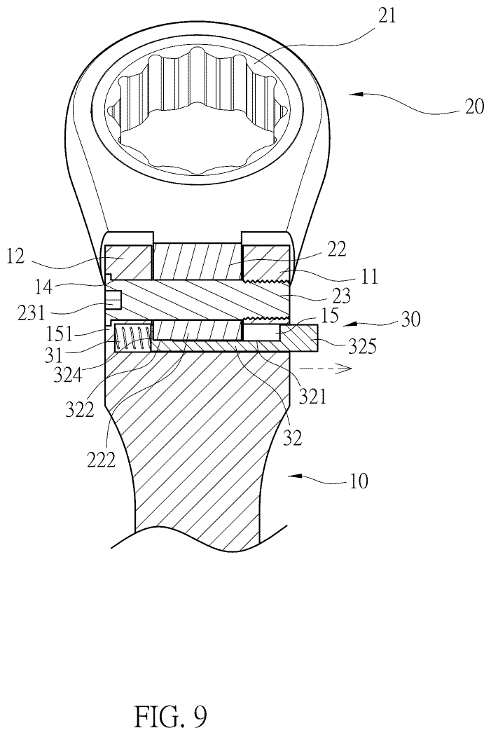

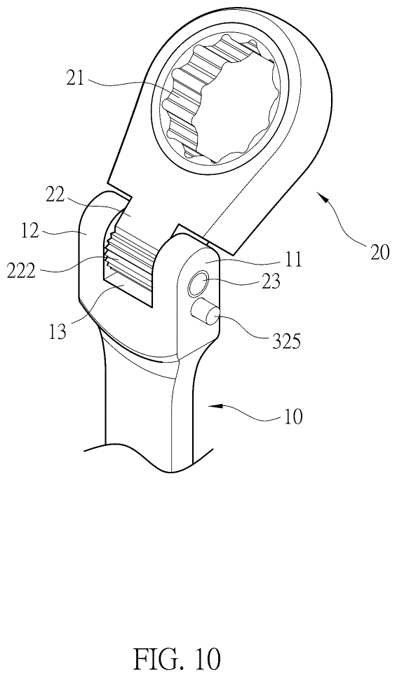

In actual application, referring to FIGS. 4 and 5, when the control column (32) of the control member (30) is not pressed, the detent teeth (323) of the locking section (322) are in a normal engaged state with the locking teeth (223) of the locking portion (222) of the pivot lug (22), so as to restrict the working angle of the tool head (20) on the handle (10) for the user to tighten or loosen a workpiece, and when the user needs to adjust the angle of the tool head (20), referring to FIGS. 6 to 8, by pressing the control column (32) to compress the elastic member (31) inwardly, the locking section (322) of the control column (32) is retracted into the detent hole (15) of the second lug (12), Meanwhile, the freewheel section (321) is moved to face the connecting space (13), and the locking teeth (223) of the locking portion (222) are disengaged from the detent teeth (323), allowing the pivot lug (22) to rotate freely within the freewheel section (321) and adjusting the angle of the tool head (20). Referring to FIGS. 9 and 10, after adjusting the angle, the control column (32) is released, and the elastic member (31) is adapted to press the control column (32) back to its original position, and the locking section (322) is configured to slide out of the detent hole (15) of the second lug (12) and move back into the interconnected arc groove (131), facing the connecting space (13). Furthermore, the detent teeth (323) are engaged with the locking teeth (223) of the pivot lug (22) to securely fix the angle of the tool head (20).

Comparing with conventional ratcheting combination wrench, the present invention is advantageous because: (i) the control member (30) is connected into the detent hole (15) in the position parallel to the locking portion (222) so that when the handle (10) and the tool head (20) are locked through the control member (30), the locking section (322) of the control column (32) are firmly engaged and positioned with the locking portion (222), so as to effectively balance the forces and reduce structural stress, further minimizing the risk of tooth wear, deformation, or even breakage; and (ii) when adjusting the tool head, pressing the control column (32) to retract the locking section (322), and the locking section (322) is disengaged with the locking section (222) of the pivot lug (22), allowing the tool head (20) to be adjusted freely, and releasing the control column (32) allows the elastic member (31) to push the control column (32) back to its original position, quickly engage the locking section (322) with the locking portion (222), so as to easily adjust the angle and position of the tool head (20), thereby enhancing the practicality and durability of the wrench.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A ratcheting combination wrench comprising a handle, a tool head, and a control member;
wherein the handle has a first lug and a second lug which are located symmetrically at one end of the handle, and a connecting space is formed between the first lug and the second lug; a shaft hole penetrates through the first lug and the second lug to communicate with the connecting space; a detent hole penetrating through the first lug and the second lug is located below the shaft hole, and a partial of the detent hole is located below the bottom surface of the connecting space, and an interconnected arc groove is formed on the bottom surface of the connecting space corresponding to the detent hole, and a stop wall is formed on the outer side of the second lug to block the outer end of the detent hole;
wherein the tool head comprises a working teeth and a pivot lug, and an axis hole penetrates through two ends of the pivot lug; the axis hole is oriented in a direction different from and intersecting with the diameter direction of the working teeth, and a shaft bolt passes through the shaft hole and the axis hole to pivotally secure the pivot lug with the handle so that the pivot lug is adapted to swing back and forth within the connecting space; the bottom edge of the pivot lug has an arc-shaped locking portion centered around the axis hole, and the locking portion has continuous locking teeth on the outer periphery; and
wherein the control member has an elastic member and a control column, and the elastic member positioned into the detent hole of the second lug is abutted against the stop wall at one end, and the control column is positioned between the detent hole and the interconnected arc groove; a freewheel section and a locking section are formed on the outer periphery of the control column, and the freewheel section is cut horizontally to form a flat plane; a plurality of detent teeth protrude from the surface of the locking section and are located higher than the freewheel section; the freewheel section and the locking section are respectively received in the interconnected arc groove and faced to the connecting space; the detent teeth of the locking section protrude into the connecting space to interlock with the locking teeth of the locking portion, enabling synchronized movement; an end of the control column adjacent to the locking section has a locating wall which is abutted against the locking section, and the locating wall is abutted against the other end of the elastic member, and the angle and position of the tool head is adjusted through pressing and releasing the control column.

2. The ratcheting combination wrench of claim 1, wherein the shaft hole on the first lug comprises an internal thread section on the inner periphery of shaft hole, and the shaft bolt has a tool hole at one end and an external thread section at the other end, so as to screw and secure the shaft bolt together with the shaft hole.

3. The ratcheting combination wrench of claim 1, wherein at least half of the detent hole is positioning below the bottom surface of the connecting space.

4. The ratcheting combination wrench of claim 1, wherein the area of the freewheel section is greater than the width of the locking portion of the pivot lug, and the area of the locking section is smaller than the freewheel section and is configured to be fully put into the detent hole of the second lug.

5. The ratcheting combination wrench of claim 1, wherein the other end of the control column has a pressing portion protruding out from the detent hole of the first lug.

6. The ratcheting combination wrench of claim 1, wherein the locking teeth of the pivot lug cover at least half of the locking portion.
